(19) United States
(12) Patent Application Publication
(10) Pub. No.: US 2025/0117403 A1
(43) Pub. Date: Apr. 10, 2025

(54) APPARATUS AND METHOD FOR MANAGING DATA BASED ON HYPER ONTOLOGY

(71) Applicant: Electronics and Telecommunications Research Institute, Daejeon (KR)

(72) Inventor: Ock Kee BAEK, Daejeon (KR)

(73) Assignee: Electronics and Telecommunications Research Institute, Daejeon (KR)

(21) Appl. No.: 18/906,488

(22) Filed: Oct. 4, 2024

(30) Foreign Application Priority Data
Oct. 5, 2023 (KR) 10-2023-0132486

(51) Int. Cl. G06F 16/28

(52) U.S. Cl. CPC G06F 16/283

(57) ABSTRACT

The present invention relates to an apparatus and method for managing data based on hyper ontology. The apparatus for managing data based on hyper ontology includes a data input module for receiving data manually input by a person and data automatically generated by a machine device, and a processor that matches a data entity in a specific technical field or specific domain with a data entity in another technical field or another domain on the basis of hyper ontology associated with a vocabulary and dictionary pre-stored in a storage module.

### CROSS-REFERENCE TO RELATED APPLICATION

This application claims priority to and the benefit of Korean Patent Application No. 10-2023-0132486, filed on Oct. 5, 2023, the disclosure of which is incorporated herein by reference in its entirety.

### BACKGROUND

### 1. Field of the Invention

The present invention relates to an apparatus and method for managing data based on hyper ontology.

### 2. Discussion of Related Art

Generally, ontology is referred to as “ontology” and originally refers to a philosophical area of study that discusses the meaning of existence of things. This ontology is a field that deals with “what kinds of beings (physical, phenomenal, conceptual, abstract, emotional) exist in this world, what is their nature (essence), what relationships exist between those beings, and how the world can be constructed from those beings.” In addition, ontology also comes from a compound word of the Greek word “onto,” which has the meaning of “reality,” and “logia,” which has the meaning of “study” or “lecture.”

Ontology in the recent information technical field, such as the Semantic Web, knowledge engineering, artificial intelligence, and natural language processing, refers to a research field that determines where each piece of knowledge (or word, or concept) is located in the entire knowledge system and refers to a research field that helps to search for correlations between words or phrases more quickly and conveniently.

Hyper is a prefix meaning the best, exceeding, etc. Hyper ontology refers to ontology with a more advanced concept than existing ontology.

Existing data management technologies and related standards are mainly focused on a syntactic aspect of data (i.e., a formal aspect of data) rather than the semantic properties of data (i.e., the meaning of data). Accordingly, there is a problem of not being able to meet the complex requirements of the Information and Communications Technology (ICT) field (e.g., access and management of high-dimensional, heterogeneous, multi-mode, and distributed big data), where the meaning of one word can be used in various meanings depending on the technical field.

### SUMMARY OF THE INVENTION

The present invention is directed to providing an apparatus and method for managing data based on hyper ontology that enable access to high-dimensional, heterogeneous, multi-mode, and distributed data such as electronic health records by allowing semantic properties of a data entity (i.e., meaning of data) to be provided through dynamic generation and maintenance of semantic and syntactical metadata based on hyper ontology.

According to an aspect of the present invention, there is provided an apparatus for managing data based on hyper ontology, which includes a data input module that receives data manually input by a person and data automatically generated by a machine device, and a processor that matches a data entity in a specific technical field or specific domain with a data entity in another technical field or another domain on the basis of hyper ontology associated with a vocabulary and dictionary pre-stored in a storage module.

In the present invention, the data input module includes a human-machine interface.

In the present invention, the processor executes a machine learning or deep learning algorithm and performs big data analysis according to a preset smart data interface or algorithm.

In the present invention, the processor performs matching of data entities in different technical fields or different domains by performing semantic analysis of data corresponding to semantic properties of data and formal analysis of data corresponding to syntactic aspects of data.

In the present invention, the storage module stores at least one of a controlled vocabulary and synonym dictionary for hyper ontology, big data and corresponding metadata in at least one specific technical field or another domain, a smart data interface for performing semantic analysis of data corresponding to semantic properties of data and formal analysis of data corresponding to syntactic aspects of data, a machine learning or deep learning algorithm, and an algorithm or framework for performing matching of data entities in different technical fields or other domains.

In the present invention, the processor automatically generates metadata to perform matching of data entities.

In the present invention, the hyper ontology manages a controlled vocabulary and corresponding synonym dictionary for each domain.

In the present invention, the metadata includes semantic properties and syntactical properties of each data entity of a data object or big data.

In the present invention, when new data is input, the processor stores the new data in the storage module and updates metadata together with a data path or storage location information (URL) for accessing data.

In the present invention, when new data is input, the processor does not delete a data entity and related metadata stored in the storage module but maintains the data entity and related metadata in a different version, and manages data such that a data entity and related metadata of a current version are placed at an uppermost level of the storage module.

According to another aspect of the present invention, there is provided a method of managing data based on hyper ontology, which includes receiving, by a processor, data manually input by a person (human-generated data) and data automatically generated by a machine device (machine-generated data) through a data input module, and matching, by the processor, a data entity in a specific technical field or specific domain with a data entity in another technical field or another domain on the basis of hyper ontology associated with a vocabulary and dictionary pre-stored in a storage module.

In the present invention, the data input module includes a human-machine interface.

In the present invention, the processor executes a machine learning or deep learning algorithm and performs big data analysis according to a preset smart data interface or algorithm.

In the present invention, the processor performs matching of data entities in different technical fields or different domains by systematically performing semantic analysis of data corresponding to semantic properties of data and formal analysis of data corresponding to syntactic aspects of data.

In the present invention, the storage module stores at least one of a controlled vocabulary and synonym dictionary for hyper ontology, big data and corresponding metadata in at least one specific technical field or another domain, a smart data interface for performing semantic analysis of data corresponding to semantic properties of data and formal analysis of data corresponding to syntactic aspects of data, a machine learning or deep learning algorithm, and an algorithm or framework for performing matching of data entities in different technical fields or other domains.

In the present invention, in order to perform the matching of the data entity, the processor automatically generates metadata to perform matching of data entities.

In the present invention, the hyper ontology manages a controlled vocabulary and corresponding synonym dictionary for each domain.

In the present invention, the metadata includes semantic properties and syntactical properties of each data entity of a data object or big data.

In the present invention, when new data is input, the processor stores the new data in the storage module and updates metadata together with a data path or storage location information (URL) for accessing data.

In the present invention, when new data is input, the processor does not delete a data entity and related metadata stored in the storage module but maintains the data entity and related metadata in a different version, and manages data such that a data entity and related metadata of a current version are placed at an uppermost level of the storage module.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an exemplary diagram showing a schematic configuration of an apparatus for managing data based on hyper ontology according to an embodiment of the present invention;

FIG. 2 is an exemplary diagram for schematically describing a configuration for generating metadata for data entities of different technical fields in FIG. 1;

FIG. 3 is an exemplary diagram for describing a method of generating metadata for data entities of different technical fields in FIG. 1; and

FIG. 4 is an exemplary diagram for describing a matching method of generating metadata for data entities of different technical fields in FIG. 3.

### DETAILED DESCRIPTION OF EXEMPLARY EMBODIMENTS

Hereinafter, embodiments of the present invention will be described with reference to the accompanying drawings.

In this description process, the thicknesses of the lines depicted in the drawing and the sizes of the components may be exaggerated for the sake of clarity and convenience of explanation. In addition, terms described below are terms defined in consideration of their functions in the present invention, and may vary depending on the intention or custom of the user or operator. Therefore, the definitions of these terms should be made based on the contents throughout this specification.

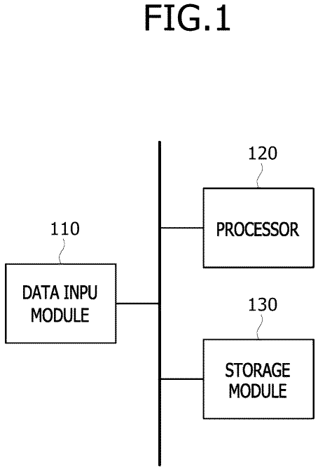

FIG. 1 is an exemplary diagram showing a schematic configuration of an apparatus for managing data based on hyper ontology according to an embodiment of the present invention.

As shown in FIG. 1, the apparatus for managing data based on hyper ontology according to the embodiment includes a data input module 110, a processor 120, and a storage module 130.

The data input module 110 may receive data automatically generated by the processor 120 (or machine device). Here, the concept of the machine device includes an electronic device including a processor that is automatically operated by an algorithm.

The data input module 110 may receive data manually input by a person (human).

The data input module 110 may include a human-machine interface for receiving automatically generated data or manual input data.

The processor 120 may execute a machine learning (or deep learning) algorithm.

The processor 120 may execute a preset smart data interface (API).

The processor 120 may execute big data analysis according to a preset algorithm.

The processor 120 may match a data entity meaning a data entity (big data and corresponding metadata) in a specific technical field (or a specific domain), which is stored in the storage module 130, with a data entity in another technical field (or another domain) on the basis of hyper ontology associated with a vocabulary and dictionary (e.g., a controlled vocabulary, synonym dictionary, etc.) pre-stored in the storage module 130 through the preset smart data interface (API).

That is, the processor 120 may generate and manage the data entity in another technical field (or another domain) corresponding to (matching) the data entity (big data and corresponding metadata) in a specific technical field (or specific domain) stored in the storage module 130.

The processor 120 may perform matching of data entities in different technical fields (or other domains) by performing content analysis of data (i.e., semantic analysis of data corresponding to semantic properties of data) and structure analysis of data (i.e., formal analysis of data corresponding to syntactic aspects of data).

The storage module 130 may store vocabulary and dictionary (e.g., a controlled vocabulary, synonym dictionary, etc.) data for hyper ontology, big data and corresponding metadata in at least one specific technical field (or other domain), a smart data interface (API) for performing content analysis of data (i.e., semantic analysis of data corresponding to semantic properties of data) and structural analysis of data (i.e., formal analysis of data corresponding to syntactic aspects of data), a machine learning (deep learning) algorithm, and an algorithm (or framework) for performing matching of data entities in different technical fields (or other domain) (i.e., generation and management of metadata).

Hereinafter, an operation of the processor 120 will be described in more detail.

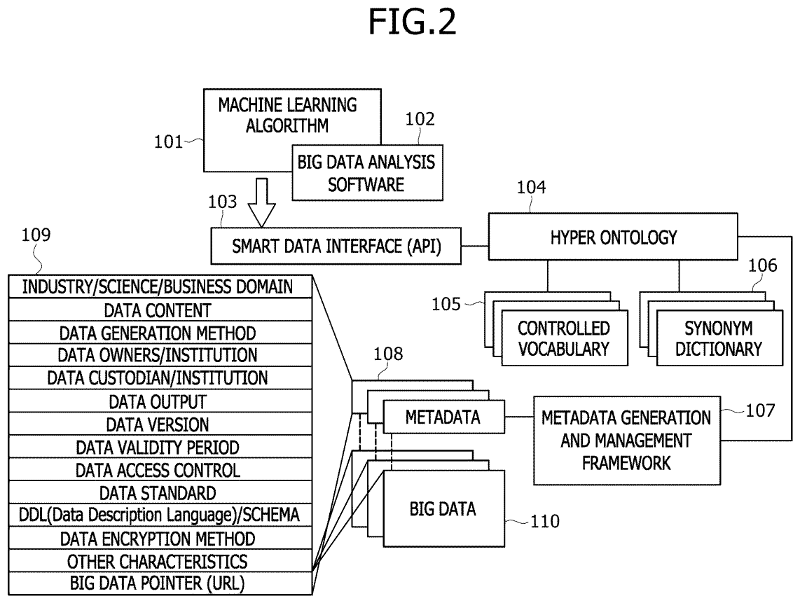

FIG. 2 is an exemplary diagram for schematically describing a configuration for generating metadata for data entities of different technical fields in FIG. 1.

Referring to FIG. 2, the processor 120 may collect and utilize various types of heterogeneous data (i.e., data in various technical fields) by using a smart data interface (API) 103 that executes a machine learning algorithm 101 or big data analysis software 102.

The processor 120 allows the machine learning algorithm 101 or data analysis software 102 to access various types of heterogeneous data (i.e., data in various technical fields) using the smart data interface (API) 103 through a metadata generation and management framework 107.

The processor 120 uses the metadata generation and management framework 107 based on hyper ontology 104, and the hyper ontology 104 may manage controlled vocabularies for each domain (e.g., COAR vocabularies) 105 and a corresponding thesaurus 106 (i.e., a structured vocabulary group showing hierarchical relationships, dependencies, and other relationships of synonyms, antonyms, and terms).

The processor 120 may automatically generate metadata 108 when human-generated data (i.e., data input by a person) or machine-generated data (i.e., data generated by a machine) is collected and stored through the metadata generation and management framework 107.

In this case, the metadata 108 includes semantic properties of a data object 110 (or each data entity of big data) and syntactic properties of the data object 110.

For reference, detailed properties of the semantic properties and the syntactic properties of the data object 110 are exemplarily described in a table 109.

Here, a data path or uniform resource locator (URL) for accessing the data object 110 may be included in the metadata, such as in the table 109. Accordingly, the data object 110 (or each data entity of big data) may be stored anywhere as long as the data object 110 can be accessed online.

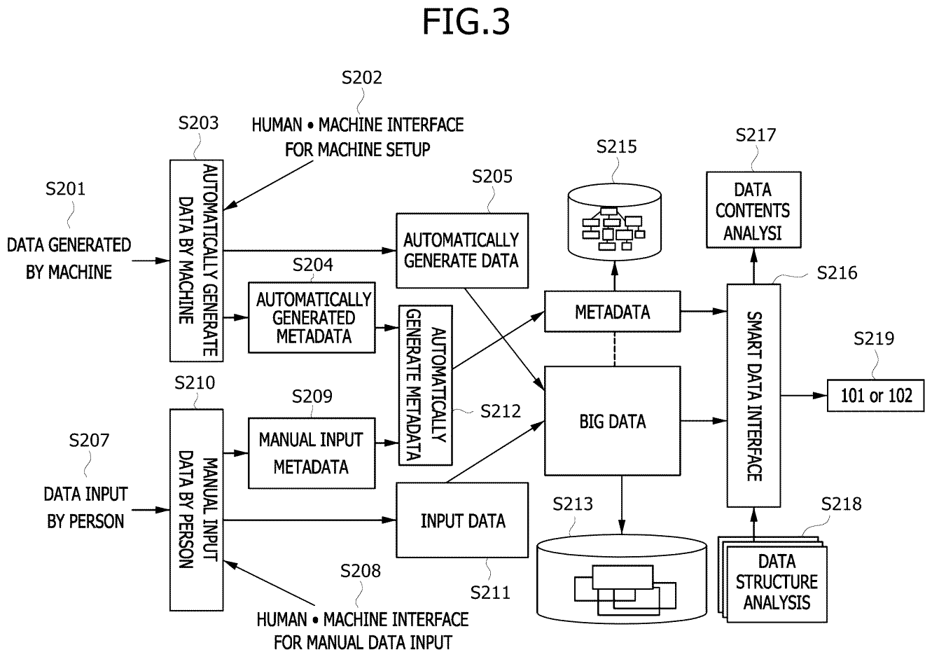

FIG. 3 is an exemplary diagram for describing a method of generating metadata for data entities of different technical fields in FIG. 1, and more specifically, illustrates the method of generating metadata for data entities that the processor 120 may collect and utilize through the smart data interface (API) 103.

In the case of machine-generated data (S201), the machine device (or processor) may be configured using runtime parameters through the human-machine interface.

For reference, a machine configuration and runtime parameters may be captured as data descriptors (S202). However, the details of the machine configuration and runtime parameters may vary depending on a machine type and purpose. Therefore, in the embodiment, the description will be focused on the concept.

When the machine device (or processor) automatically starts generating new data (or a new dataset) (S203), the processor 120 may automatically generate metadata for the new data (or the new dataset) by searching for metadata properties for the new data (or the new dataset) (S212).

In addition, when the machine device (or processor) automatically starts generating new data (S203), the processor 120 may capture the new data (S205) and store the new data as big data in the storage module 130 (or a data storage system) (S213).

In this case, the metadata generated for the new data may be updated together with a data path or the URL for accessing data (S214).

The metadata updated together with the data path or the URL for accessing data (S214) may be organized based on a classification method (e.g., a method of classifying metadata by industry and business domains, scientific field and branch, etc.) and may be inserted into a hierarchy of data entities persisted in the storage module 130.

For reference, by capturing new data (S205), data entities (S213) and related metadata (S215) stored in the storage module 130 (or data storage system) are not deleted from the device but are maintained with another version, and a data entity and related metadata of the current version may be placed at the uppermost level of a data chain. In this case, the purpose of maintaining all data entities and related metadata through version management is to ensure traceability of data management (or governance) and to discover trends.

Meanwhile, in the case of data (S207) generated (or input) by a person, when the input of data generated by the person begins (S210), the processor 120 may display (output) a message asking for semantic and syntactic information about the data.

Information about human-generated data (i.e., data manually input by a person) may be captured as a data descriptor used to generate metadata (S209).

Information about human-generated (or input) data (e.g., property information) may be used to automatically generate metadata (S212).

The processor 120 may capture human-generated (or input) (S210) data (S211) and store the data as big data in the storage module 130 (or data storage system) (S213).

Meanwhile, a predefined smart data interface (S216), such as the data path or URL for accessing data, may be provided and used by the processor 120 that executes the big data analysis software 102 or machine learning algorithm 101.

The data path or URL may be obtained by searching the data hierarchy (S215).

The preset smart data interface (S216) may access metadata (S214) stored in a metadata repository of the storage module 130 (S215) and return semantic properties of the data to be accessed.

The processor 120 executing the big data analysis software 102 or machine learning algorithm 101 may search for the semantic properties of data (S217) (i.e., performs data content analysis), find syntactic properties of the data in metadata, and access the data through the corresponding structure analysis of data (S218).

Then, actual data may be returned to the processor 120 executing the big data analysis software 102 or machine learning algorithm 101 as a result of the data path or URL requested for data access.

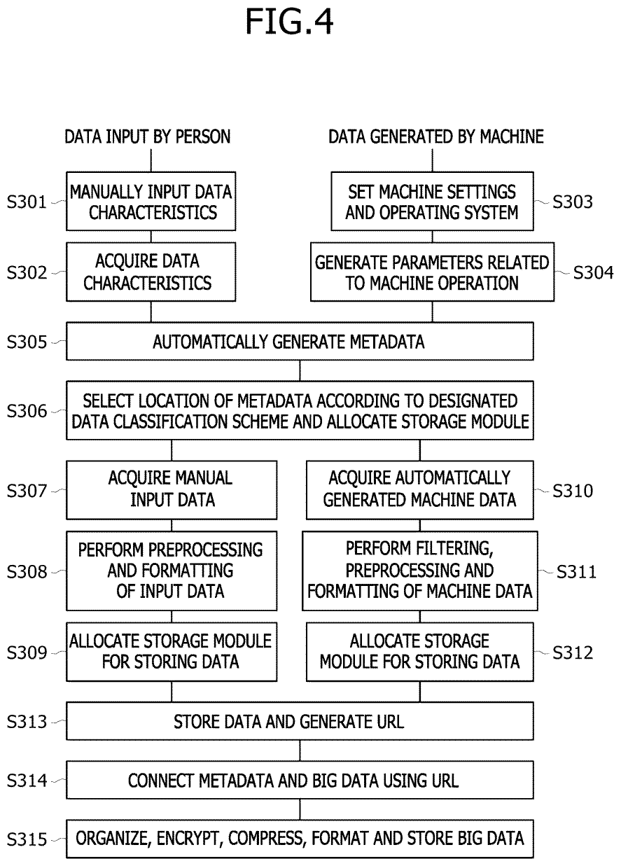

FIG. 4 is an exemplary diagram for describing a matching method of generating metadata for data entities of different technical fields in FIG. 3.

Referring to FIG. 4, the processor 120 may acquire data characteristics from data manually input by a person (S301 and S302), set machine settings and operating systems by receiving data generated by a machine, and generate parameters related to machine operation (S303 and S304).

The processor 120 may automatically generate metadata based on the characteristics (or properties) of data by receiving the data input by the person and the data generated by the machine (S305).

The processor 120 may select a location of metadata according to a designated data classification system and allocate a storage module (S306).

The processor 120 may acquire data manually input by a person (S307), perform preprocessing and formatting on the corresponding input data (S308), and allocate a storage module for storing data (S309).

The processor 120 may acquire data automatically generated by the machine (S310), perform filtering, preprocessing, and formatting of the machine data (S311), and allocate a storage module for storing data (S312).

When the storage module for storing data is allocated (S309 and S312), the processor 120 stores data in the allocated storage module, generates storage location information (URL) (S313), connects metadata and big data using the storage location information (URL) (S314), and performs big data configuration, encryption, compression, formatting, and storage (S315).

As described above, the present invention solves the inaccessibility of high-dimensional, heterogeneous, and distributed data by enabling the semantic and syntactic data to be discovered, enables a semantic scheme to be systematically found immediately at the time of data access through a pre-set smart data interface (e.g., an API or an application programming interface), and enables the semantics and syntax of data to be discovered in a systematic manner without programming during data collection without prior knowledge because machine-readable data descriptors as well as human-readable data descriptors are used to describe semantic properties and syntactic aspects of data.

In addition, when used in conjunction with an integrated indexing mechanism, dynamic metadata management based on ontology not only enables access to multidimensional heterogeneous data, but also enables dynamic metadata management. In the dynamic metadata management based on ontology, data management such as semantic categories provided by experts in a specific domain (e.g., a protein structure, a human genome sequence, a protein structure, crystallography of moon rocks, brain Positron Emission Tomography (PET) scans, chest X-rays, electroencephalography (EEG), heart or lung auscultation, gene expression data), a data owner and version (e.g., a generation date and time, a geographic code, an institution code, a medical device identifier), data dimensions (e.g., binary, a character string, an image, an extensible Markup Language (XML), relational), data formats (e.g., a Binding Schema Markup Language (BSML), a Microarray Gene Expression Markup Language (MAGE-ML), Clinical Document Architecture/Health Level 7 (CDA/HL7), a Population Stability Index (PSI), and a Data Format Description Language (DFDL)), etc. may be performed, and, for data descriptors, XML notation may be used to make the data descriptors readable by people as well as machines.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

According to the present invention, high-dimensional, heterogeneous, multi-mode, and distributed data such as electronic health records can be accessed by allowing semantic properties of a data entity (i.e., meaning of data) to be provided through dynamic self-generation and maintenance of semantic and syntactical metadata based on hyper ontology.

According to the present invention, systematic collection, verification, curation, analysis, and management of high-dimensional, heterogeneous, and distributed big data are possible without the need to develop individual data adapters and preprocessors, even without prior knowledge of data in other technical fields.

What is claimed is:

1. An apparatus for managing data based on hyper ontology, comprising:
a data input module that receives data manually input by a person and data automatically generated by a machine device; and
a processor that matches a data entity in a specific technical field or specific domain with a data entity in another technical field or another domain on the basis of hyper ontology associated with a vocabulary and dictionary pre-stored in a storage module.

2. The apparatus of claim 1, wherein the data input module includes a human-machine interface.

3. The apparatus of claim 1, wherein the processor executes a machine learning or deep learning algorithm and performs big data analysis according to a preset smart data interface or algorithm.

4. The apparatus of claim 1, wherein the processor performs matching of data entities in different technical fields or different domains by performing semantic analysis of data corresponding to semantic properties of data and formal analysis of data corresponding to syntactic aspects of data.

5. The apparatus of claim 1, wherein the storage module stores at least one of a controlled vocabulary and synonym dictionary for hyper ontology, big data and corresponding metadata in at least one specific technical field or another domain, a smart data interface for performing semantic analysis of data corresponding to semantic properties of data and formal analysis of data corresponding to syntactic aspects of data, a machine learning or deep learning algorithm, and an algorithm or framework for performing matching of data entities in different technical fields or other domains.

6. The apparatus of claim 1, wherein the processor automatically generates metadata to perform matching of data entities.

7. The apparatus of claim 1, wherein the hyper ontology manages a controlled vocabulary and corresponding synonym dictionary for each domain.

8. The apparatus of claim 6, wherein the metadata includes semantic properties and syntactical properties of each data entity of a data object or big data.

9. The apparatus of claim 6, wherein, when new data is input, the processor stores the new data in the storage module and updates metadata together with a data path or storage location information (URL) for accessing data.

10. The apparatus of claim 9, wherein, when new data is input, the processor does not delete a data entity and related metadata stored in the storage module but maintains the data entity and related metadata in a different version, and manages data such that a data entity and related metadata of a current version are placed at an uppermost level of the storage module.

11. A method of managing data based on hyper ontology, comprising:
receiving, by a processor, data manually input by a person and data automatically generated by a machine device through a data input module; and
matching, by the processor, a data entity in a specific technical field or specific domain with a data entity in another technical field or another domain on the basis of hyper ontology associated with a vocabulary and dictionary pre-stored in a storage module.

12. The method of claim 11, wherein the data input module includes a human-machine interface.

13. The method of claim 11, wherein the processor executes a machine learning or deep learning algorithm and performs big data analysis according to a preset smart data interface or algorithm.

14. The method of claim 11, wherein the processor performs matching of data entities in different technical fields or different domains by performing semantic analysis of data corresponding to semantic properties of data and formal analysis of data corresponding to syntactic aspects of data.

15. The method of claim 11, wherein the storage module stores at least one of a controlled vocabulary and synonym dictionary for hyper ontology, big data and corresponding metadata in at least one specific technical field or another domain, a smart data interface for performing semantic analysis of data corresponding to semantic properties of data and formal analysis of data corresponding to syntactic aspects of data, a machine learning or deep learning algorithm, and an algorithm or framework for performing matching of data entities in different technical fields or other domains.

16. The method of claim 11, wherein, in order to perform the matching of the data entity, the processor automatically generates metadata to perform matching of data entities.

17. The method of claim 11, wherein the hyper ontology manages a controlled vocabulary and corresponding synonym dictionary for each domain.

18. The method of claim 16, wherein the metadata includes semantic properties and syntactical properties of each data entity of a data object or big data.

19. The method of claim 16, wherein, when new data is input, the processor stores the new data in the storage module and updates metadata together with a data path or storage location information (URL) for accessing data.

20. The method of claim 19, wherein, when new data is input, the processor does not delete a data entity and related metadata stored in the storage module but maintains the data entity and related metadata in a different version, and manages data such that a data entity and related metadata of a current version are placed at an uppermost level of the storage module.
